(19) United States
(12) Patent Application Publication
(10) Pub. No.: US 2025/0175053 A1
(43) Pub. Date: May 29, 2025

(54) Rotor for an Electric Traction Machine of a Motor Vehicle, and Electric Traction Machine

(71) Applicant: Bayerische Motoren Werke Aktiengesellschaft, Muenchen (DE)

(72) Inventors: Benjamin KRANK, Muenchen (DE); Bernhard WOLF, Muenchen (DE)

(21) Appl. No.: 18/841,527

(22) PCT Filed: Apr. 11, 2023
(86) PCT No.: PCT/EP2023/059357

§ 371 Date: Aug. 26, 2024

(30) Foreign Application Priority Data
May 9, 2022 (DE) 10 2022 111 413.9

(51) Int. Cl. H02K 5/15; H02K 1/24; H02K 7/00; H02K 9/19

(52) U.S. Cl. CPC H02K 5/15; H02K 1/24; H02K 7/003; H02K 9/19

(57) ABSTRACT

A rotor for an electric traction machine of a motor vehicle has a rotor main body, which has a laminated core and a plurality of rotor windings extending through the laminated core, and at least one end-face component arranged at the end face on the rotor main body, covers the rotor windings axially outwardly, and, on its side facing the rotor main body, has a geometry that corresponds to an outer contour of the rotor windings.

### BACKGROUND AND SUMMARY

The invention concerns a rotor for an electric traction machine of a motor vehicle, and an electric traction machine for a motor vehicle.

Effective rotor cooling of electric drive machines is a major challenge for a high sustained power level, in particular in power-excited synchronous machines and in asynchronous machines. A high sustained power level is essential for dynamic driving behavior, such as e.g. dynamic driving on rural roads. Too rapid a heating of the rotor can lead to degradation of the drive. As a result, essential vehicle objectives may not be achieved. Improved rotor cooling allows a significant increase in sustained power for given dimensions of a traction machine.

EP 3 068 021 A1 discloses an electric rotary machine with integrated permanent magnet, which comprises a stator and a rotor. The rotor comprises an annular rotor core, a shaft which is pressed into a central opening of the rotor core, multiple permanent magnets and two end plates which are pressed onto the shaft and thereby fastened to the shaft, and arranged such that they touch the two respective axial end faces of the rotor core.

Furthermore, WO 2018/137955 A1 discloses an electric machine with a rotor arranged rotationally fixedly on a rotor shaft, and a stator. An axial coolant supply line is arranged in the rotor shaft. The rotor has a laminated core, and a radial coolant supply line of the electric machine is connected coolant-conductively to at least one lamination gap of the laminated core.

An object of the present invention is to create a solution which allows a particularly efficient cooling of a rotor of an electric traction machine.

This object is achieved according to the invention by the subjects of the present disclosure. Further possible embodiments of the invention are also disclosed in the description and the figures.

The invention concerns a rotor for an electric traction machine of a motor vehicle. The electric traction machine is configured to form part of an electric drive train of the motor vehicle and drive the motor vehicle by electrical energy. The rotor may also be known as an armature. In addition to the rotor, the electric machine may comprise a stator, relative to which the rotor rotates about a rotational axis on operation of the electric traction machine. The rotor has a rotor base body which comprises a laminated core and a plurality of rotor windings extending through the laminated core.

The rotor furthermore comprises at least one end-face component which is arranged on the end face of the rotor base body. This end-face component covers the rotor windings axially outwardly and, on its side facing the rotor base body, corresponds in its geometry to an outer contour of the rotor windings. The axial direction of the rotor coincides with the rotational axis of the rotor. This means that the end-face component covers the rotor windings towards the front or rear along the rotational axis. In particular, the rotor comprises two end-face components which are arranged on axially mutually opposite end faces of the rotor base body.

The rotor windings are the respective conductors which run together in a groove of the laminated core and, on the end face of the rotor base body, are bent from one groove of the laminated core into a further groove of the laminated core, whereby the rotor winding assumes a U shape in the region of this bend. This U-shaped region of the respective rotor winding corresponds to the side of the end-face component facing the rotor base body. The “correspondence of the rotor windings to the side of the end-face component facing the rotor base body” means that the geometry of the end-face component, on its side facing the rotor base body, follows the outer contour of the rotor windings, whereby the end-face component can be brought particularly close to the rotor windings, whereby a gap between the rotor windings and the end-face component can be kept particularly small.

The at least one end-face component is configured to transport heat away from the rotor windings by heat conduction, whereby the rotor windings are cooled. Because the geometry of the end-face component on its side facing the rotor base body corresponds to the outer contour of the rotor windings, the end-face component can be arranged particularly close to the respective rotor windings, whereby heat can be transported away from the rotor windings via the end-face component particularly quickly and over a particularly large area of the end-face component. Thus a particularly efficient cooling of the rotor windings of the rotor can be achieved, whereby again the electric traction machine can be operated particularly efficiently, in particular with a particularly high sustained power.

In a further embodiment of the invention, it is provided that for each rotor winding, the end-face component has a recess, the surface contour of which corresponds to the surface contour of the respective assigned rotor winding. Here, the respective recess corresponds to the U-shaped recess of the respective assigned rotor winding. The respective U-shaped regions of the rotor windings protrude at least in regions beyond the laminated core of the rotor base body, and thus have a particularly similar geometry to that of the recess. Accordingly, by pushing the respective recesses over assigned rotor windings, the end-face component can be placed particularly close to the rotor base body. This allows a particularly efficient transport of heat away from the rotor windings via the end-face component, and accordingly a particularly efficient cooling of the rotor.

In a further embodiment of the invention, it is provided that on its side facing the rotor base body, the end-face component is coated with an electrically isolating insulation layer. By this insulation layer, the rotor windings are electrically isolated axially towards the outside. Current conduction via the end-face component can thus be suppressed particularly well by the insulation layer. This allows a particularly safe operation of the rotor.

In a further embodiment of the invention, it is provided that the end-face component is ribbed on its side facing the rotor base body. A ribbed design of the end-face component means that the end-face component has multiple ribs, in particular a plurality of ribs, on its side facing the rotor base body. In particular, a height of the ribs extends in the axial direction of the rotor. The height runs along the shortest path from a foot of the respective rib to a free end of the respective rib. The ribs allow firstly a particularly stable configuration of the end-face component for a particularly low weight of the end-face component, and secondly a particularly large surface area of the end-face component on its side facing the rotor base body. Via the particularly large surface area of the end-face component on its side facing the rotor base body, the end-face component can absorb a particularly large amount of heat from the rotor base body, whereby the rotor base body can be cooled particularly well.

Furthermore, the ribbed design of the end-face component on its side facing the rotor base body means that the end-face component can be produced in a diecasting process. To keep a distortion of the end-face component particularly low during hardening when produced in the diecasting process, large accumulations of material must be avoided. This is implemented by the provision of ribs. Furthermore, the design of the end-face component with ribs of equal thickness allows an even hardening of the end-face component during diecasting, whereby a probability of an occurrence of shrink holes can be kept particularly low. The ribbed design of the end-face component thus allows the end-face component to be produced in a diecasting process with particularly few shrink holes.

In a further possible embodiment of the invention, it is provided that the end-face component is made of metal. Here, the end-face component may be formed solely of a single metal or from an alloy comprising at least one metal. Because the end-face component comprises metal, the end-face component has a particularly high thermal conductivity. Accordingly, by the end-face component, a particularly large quantity of heat can be transported away from the rotor windings particularly quickly, whereby the rotor windings can be cooled particularly well.

In this context, in a refinement of the invention, it is provided that the end-face component is made of aluminum. Here, the end-face component may for example be made from aluminum in an aluminum diecasting process. Because the end-face component is formed from aluminum, the end-face component has a particularly low weight. Furthermore, aluminum has a particularly high thermal conductivity, so that by the end-face component, heat can be transported away from the rotor windings particularly quickly. This allows a particularly efficient cooling of the rotor windings.

In a further possible embodiment of the invention, it is provided that at least one cavity between the rotor base body and the end-face component is filled with a casting compound. In other words, a gap between the end-face component and the rotor base body, in particular between the end-face component and the rotor windings, is filled with the casting compound. As a result, formation of a heat-insulating air layer between the end-face component on the rotor base body can be avoided. The casting compound thus serves firstly for electrical isolation of the rotor windings, and secondly for heat conduction from the rotor windings to the end-face component. In particular because of a combination of the casting compound with the insulation layer arranged on the side of the end-face component facing the rotor body, the rotor windings are electrically isolated towards the outside particularly well. For example, if hairline cracks occur in the casting compound, the insulation layer ensures the electrical isolation of the rotor windings. By filling the cavity between the rotor base body and the end-face component with the casting compound, the end-face component and the rotor base body can be fixed in their orientation relative to one another. Slipping of the end-face component relative to the rotor base body can thus be at least substantially avoided. As a result, the end-face component is fixed particularly securely relative to the rotor base body. Accordingly, a particularly good transport of heat away from the rotor windings via the end-face component can be ensured.

In a further possible embodiment of the invention, it is provided that along its outer geometry, the side of the end-face component facing the rotor base body has a constant distance from the rotor windings. In other words, a gap occurring between the rotor windings on the end-face component, which is limited at its opposite sides by the rotor windings and by the end-face component respectively, has an at least substantially constant width. This allows an even transport of heat away from the respective rotor winding via the outer contour. Furthermore, an even transport of heat away from the rotor base body is possible over all rotor windings. This allows a particularly even cooling of the rotor windings, and so-called hotspots can be avoided particularly reliably.

The invention furthermore concerns an electric traction machine for a motor vehicle. This electric traction machine has a stator, a hollow shaft and a rotor as described above in connection with the rotor according to the invention. The rotor radially surrounds the hollow shaft over an axial length portion. The rotor is in particular arranged rotationally fixedly relative to the hollow shaft, in particular on the hollow shaft. On operation of the electric traction machine, the rotor thus rotates together with the hollow shaft about the rotational axis. The hollow shaft is configured to carry a flow of cooling fluid, whereby the rotor can be cooled via the hollow shaft. The rotor base body can thus be cooled both via the hollow shaft and also via the at least one end-face component, whereby a particularly efficient cooling of the rotor windings can be achieved.

In a refinement of the invention, it is provided that the hollow shaft has at least one radial bore via which, in operation of the traction machine, a cooling fluid emerges from the hollow shaft in order to flow along an end face of the rotor. In particular, the cooling fluid emerging from the hollow shaft flows along an end face of the end-face component. Here, the cooling fluid flows along a side of the end-face component facing away from the rotor windings, and absorbs heat from the end-face component while flowing along the end face of the end-face component, whereby the end-face component is cooled. Thus by the cooling fluid flowing along the end face of the end-face component, the heat absorbed from the rotor windings via the end-face component is transported away from the end-face component. The hollow shaft may in particular have multiple radial bores around its periphery, whereby a particularly large quantity of cooling fluid can emerge from the hollow shaft evenly over the periphery of the hollow shaft, and flow over the end face of the end-face component. This allows a particularly even cooling of the end-face component. The cooling fluid is in particular a cooling liquid such as e.g. oil. By the cooling fluid, thus the end-face component can be cooled particularly well, whereby again heat can be transported away from the rotor windings particularly efficiently. This allows a particularly efficient operation of the electric traction machine.

Furthermore, according to the invention, a method may be provided for producing a rotor as described above in connection with the rotor according to the invention. In the method, for producing the rotor base body, multiple rotor windings are laid through the laminated core. Furthermore, the at least one end-face component is arranged on the end face of the rotor base body, in particular especially close to the rotor windings. Thus a gap between the respective rotor windings and the assigned end-face component can be kept particularly small, whereby heat from the rotor windings of the rotor can be transported away from the rotor windings particularly well by the end-face component.

Further features of the invention may be given in the claims, the figures and the description of the figures. The features and feature combinations cited above in the description, and the features and feature combinations indicated below in the description of the figures and/or in the figures alone, may be applied not only in the respective combination given but also in other combinations or alone without leaving the scope of the invention.

### BRIEF DESCRIPTION OF THE DRAWINGS

FIG. 1 shows a schematic, perspective view of an end-face component for a rotor for an electric traction machine of a motor vehicle, wherein the end-face component is configured to be arranged on the end face of a rotor base body of the rotor, and on its side facing the rotor base body has multiple recesses which, in their shape, correspond to an outer contour of the rotor windings of the rotor base body, whereby the end-face component can be laid particularly close to the rotor base body, in particular at the rotor windings of the rotor base body;

FIG. 2 shows a schematic, perspective view of the rotor with a partial section through a rotor winding of the rotor, wherein the end-face component is arranged on the end face of the rotor base body, and the end-face component axially covers the rotor winding towards the outside in an extent direction of the rotational axis of the rotor, wherein the end-face component is arranged on the rotor base body such that a deflection region of the rotor winding protrudes into an assigned recess of the end-face component, wherein in the deflection region, the rotor winding is formed U-shaped in its axial longitudinal section and is deflected from a first groove of the laminated core of the rotor base body into a second groove of the laminated core, and the outer contour of the rotor winding in the deflection region corresponds to the surface contour of the recess of the end-face component; and

FIG. 3 shows a schematic, sectional view of the rotor from FIG. 2, wherein when the rotor is in assembled state, a gap exists between the respective rotor windings and the assigned recesses, which gap has an at least substantially constant width.

### DETAILED DESCRIPTION OF THE DRAWINGS

In the figures, the same elements and those with similar function carry the same reference signs.

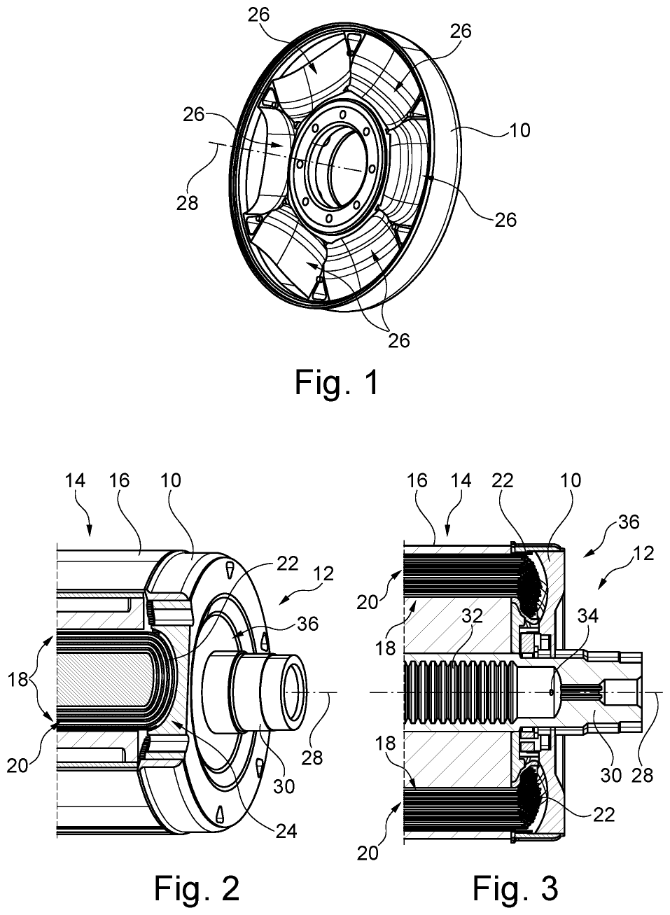

FIG. 1 shows an end-face component 10 for a rotor 12 shown in different illustrations in FIG. 2 and in FIG. 3. This rotor 12 is part of an electric traction machine which is configured to drive a motor vehicle. In addition to the rotor 12, the traction machine comprises a stator, relative to which the rotor 12 rotates about a rotational axis 28 on operation of the traction machine.

The rotor 12 comprises a rotor base body 14 in addition to the end-face component 10. The end-face component 10 may be formed as a support ring, wherein the support ring mechanically supports and stabilizes the rotor base body 14, in particular on operation of the electric traction machine. The rotor base body 14 comprises a laminated core 16 through which multiple grooves 18 pass. Each of the grooves 18 carries multiple conductors 20, wherein all conductors 20 in a groove 18 together form a rotor winding 22. The rotor winding 22, which can be seen in FIG. 2, extends through a first groove 18 of the laminated core 16 and is deflected into a second groove 18 of the laminated core 16 in a deflection region 24 on the end face of the laminated core 16. In this deflection region 24, in which the rotor winding 22 is deflected from the first groove 18 into the second groove 18 and thus bent around, the rotor winding 22 has a U-shaped longitudinal section. The respective rotor windings 22 have the U-shaped longitudinal section in a section in the extent direction of the rotational axis 28, as evident in FIG. 2. In this deflection region 24, the respective rotor winding 22 protrudes beyond the end face of the laminated core 16.

In order to allow a particularly good transport of heat away from the respective rotor windings 22, it is provided that the end-face component 10, which in the assembled rotor 12 is arranged on the end face of the rotor base body 14, on its side facing the rotor base body 14, corresponds in its geometry to the outer contour of the rotor windings 22. For this, the end-face component 10, as FIG. 1 shows particularly clearly, has a recess 26 for each rotor winding 22. The end-face component 10 is arranged on the rotor base body 14 with the respective recesses 26 pushed over the respectively assigned rotor windings 22 in the deflection region 24. As particularly clearly shown in FIGS. 2 and 3, the side of the end-face component 10 facing the rotor base body 14 can be placed particularly close to the respective rotor windings 22 because of the surface contours of the assigned recesses 26 of the end-face component 10, which correspond to the outer contour of the respective assigned rotor winding 22. As FIGS. 2 and 3 show particularly well, there is only a particularly small distance between the conductors 20 of the respective rotor windings 22 and the side of the end-face component 10 facing the rotor base body 14. In particular, the end-face component 10 has an at least substantially constant distance from the conductors 20 of the respective rotor windings 22 in the deflection region 24. As a result, a particularly even transport of heat away from the rotor windings 22 can take place via the end-face component 10.

In the present case, the recesses 26 have the form of a cylinder casing surface, wherein a center axis of the cylinder casing surface form runs in the radial direction relative to the rotational axis 28 of the rotor 12. Here, the cylinder casing surface form of the respective recesses 26 tapers towards the rotational axis 28. The end-face component 10, at least in the region of the recesses 26, is here formed from a metal, in this case aluminum. Accordingly, heat can be transported away from the rotor windings 22 via the end-face component 10 particularly quickly.

In order to avoid an insulating air layer between the respective rotor windings 22 and the end-face component 10, a casting compound is filled in the respective gaps between the rotor windings 22 and the end-face component 10. This casting compound may also serve for electrical isolation of the rotor windings 22. In order to guarantee the electrical isolation of the rotor windings 22 even if hairline cracks occur in the casting compound, the side of the end-face component 10 facing the rotor base body 14 may be coated with an electrically isolating insulation layer. In order to allow diecasting of the end-face component 10 from the metal, in particular aluminum, the end-face component 10 may have ribs on its side facing the rotor base body 14 in the installation position. This means that on its side facing the rotor base body 14, the end-face component 10 may be provided with a plurality of ribs (not shown in the figure), wherein multiple ribs may together delimit respective recesses 26 of the end-face component 10. Because of the at least partially ribbed design of the end-face component 10, large accumulations of material of the end-face component 10 can be avoided, whereby on diecasting of the end-face component 10 from aluminum, the formation of shrink holes can be at least substantially avoided. In addition, the end-face component 10 can be made particularly stable with a particularly low weight.

As evident from FIGS. 2 and 3, when installed in the electric traction machine, the rotor 12 sits rotationally fixedly on a hollow shaft 30. On operation of the electric traction machine, the rotor 12 is rotated about the rotational axis 28 together with the hollow shaft 30. The hollow shaft 30 has a cavity 32 in its interior, into which a cooling fluid can flow in order to cool the hollow shaft 30 and, via the hollow shaft 30, the laminated core 16 from the inside. The hollow shaft 30 furthermore has at least one radial bore 34, via which cooling fluid flowing into the cavity 32 can emerge from the hollow shaft 30. The cooling fluid emerging from the at least one radial bore 34 flows along the end face 36 of the end-face component 10 facing away from the rotor base body 14. The end face 36 of the end-face component 10 lies axially opposite the side of the end-face component 10 facing the rotor base body 14. In particular, the cooling fluid emerging from the hollow shaft 30 via the at least one radial bore 34 can spray onto the end face 36 of the end-face component 10, whereby the end face 36 can be particularly evenly wetted with cooling fluid. The cooling fluid in the present case is oil. The end-face component 10 is cooled by the cooling fluid flowing along the end face 36 of the end-face component 10. Thus cooling fluid transports heat away from the end-face component 10 via the end face 36 of the end-face component 10, and thereby cools the end-face component 10. The heat transport path thus runs from the rotor windings 22 via the end-face component 10 to the cooling fluid, which in turn can transfer the heat to a heat sink.

The insulation layer may be applied or sprayed onto the end-face component 10. Here, the insulation layer may be applied to the end-face component 10 only in the region of the recesses 26, whereby the insulation layer can be provided using particularly little material.

The basic concept of the described rotor 12 is that a heat dissipation at the respective rotor end faces of the rotor 12 can be improved by the cooling fluid, in particular oil and/or air sprayed thereon, insofar as the terminating end-face component 10-in the present case made of metal-lies on the rotor end face geometrically as closely as possible around the hot rotor windings 22, in order to achieve the best possible solid-body heat conduction between the rotor windings 22 and the cooling fluid via said rotor end face. Any casting compound provided or other electrical insulation layers are here made as thin as possible in order to avoid thermal insulation and hence a poor heat dissipation from the rotor windings 22. The cooling fluid sprays out of the hollow shaft 30 on its front side and on a rear side of the rotor 12, and meets the respective end faces 36 of the rotor 12—which in particular may be formed with a slope—with a radial spray pattern. Here, a flow speed of the cooling fluid along the end face 36 may be set by the slopes. This cooling of the end face 36 of the rotor 12 has a considerable influence on the cooling and hence the sustained power of the electric traction machine.

In the case of power-excited synchronous machines and in asynchronous machines, in the rotor 12, typically a space between the rotor windings 22 and surrounding components such as the end-face component 10 is filled with a plastic casting material. Whereas the end face 36 is frequently configured as a casting made from metal with high thermal conductivity, the casting compound lying behind this in the axial direction is made from the plastic casting material and, because of its electrical isolation function and flow properties, usually has a poor solid-body thermal conductivity. In order to improve this direct heat conduction path, therefore, the metallic end-face component 10 is placed as closely as possible around the rotor windings 22. In order to meet casting requirements with respect to cooling behavior and shrink hole formation, the side of the end-face component 10 facing the rotor base body 14 may be configured with multiple small ribs, which have at least approximately constant wall thicknesses and which allow a geometric proximity of the end-face component 10 to the rotor windings 22. Furthermore, the electrical isolation between the rotor windings 22 and the end-face component 10 may be achieved with a particularly small thickness of the casting compound, as the casting compound is partly replaced by a dedicated insulation coating applied to the end-face component 10.

The end-face component 10 is a so-called star disc. The end-face component 10 may be produced as a diecasting or deep-drawn component. Instead of aluminum, the end-face component 10 may alternatively be made of magnesium or a magnesium alloy. The end-face component 10 allows the rotor 12 to be kept at least approximately round during operation, which results in a streamlined form leading to particularly low friction losses. Furthermore, the end-face component 10 may have supportive properties. In addition, the end-face component 10 is configured to keep the casting compound within the rotor 12.

As a whole, the present disclosure shows how an improvement rotor cooling can be achieved by adaptation of the end-face geometry. In particular, a support ring with improved solid-body thermal conductivity is provided as the end-face component 10.

### LIST OF REFERENCE SIGNS

10 Support ring
12 Rotor
14 Rotor base body
16 Laminated core
18 Groove
20 Conductor
22 Rotor winding
24 Deflection region
26 Recess
28 Rotational axis
30 Hollow shaft
32 Cavity
34 Radial bore

1-10. (canceled)

11. A rotor for an electric traction machine of a motor vehicle, the rotor comprising:
a rotor base body comprising a laminated core and a plurality of rotor windings extending through the laminated core; and
at least one end-face component that is arranged on an end face of the rotor base body, covers the rotor windings axially outwardly, and, on its side facing the rotor base body, comprises a geometry that corresponds to an outer contour of the rotor windings.

12. The rotor according to claim 11, wherein, for each rotor winding of the plurality of rotor windings, the end-face component has a recess, a surface contour of which corresponds to a surface contour of the respective assigned rotor winding.

13. The rotor according to claim 11, wherein, on its side facing the rotor base body, the at least one end-face component is coated with an electrically isolating insulation layer.

14. The rotor according to claim 11, wherein the at least one end-face component is ribbed on its side facing the rotor base body.

15. The rotor according to claim 11, wherein the at least one end-face component is made of metal.

16. The rotor according to claim 15, wherein the at least one end-face component is made of aluminum.

17. The rotor according to claim 11, wherein at least one cavity between the rotor base body and the at least one end-face component is filled with a casting compound.

18. The rotor according to claim 11, wherein, along its outer geometry, the side of the at least one end-face component facing the rotor base body has a constant distance from the rotor windings.

19. An electric traction machine for a motor vehicle comprising:
a stator;
a hollow shaft; and
the rotor according to claim 11, which radially surrounds the hollow shaft over an axial length portion.

20. The electric traction machine according to claim 19, wherein the hollow shaft has at least one radial bore via which, in operation of the traction machine, a cooling fluid emerges from the hollow shaft and flows along an end face of the rotor.
